(19) United States
(12) Patent Application Publication
(10) Pub. No.: US 2026/0367634 A1
(43) Pub. Date: Nov. 19, 2026

(54) PREDICTED CONSTRAINTS FOR VEHICLE CONTROL

(71) Applicant: QUALCOMM Incorporated, San Diego, CA (US)

(72) Inventors: Richard Stephen SHAFFER, Jenkintown, PA (US); Vinay Kumar SENTHIL KUMAR, Philadelphia, PA (US); Pranav DESAI, San Diego, CA (US)

(21) Appl. No.: 19/641,280

(22) Filed: Apr. 7, 2026

Related U.S. Application Data
(60) Provisional application No. 63/806,561, filed on May 15, 2025.

(51) Int. Cl. G05D 1/617; G05D 101/15

(52) U.S. Cl. CPC G05D 1/617; G05D 2101/15

(57) ABSTRACT

Some vehicles utilize an autonomous driving system or advanced driver assistance system (ADAS) to provide automated driving functionality. When active, autonomous driving or ADAS may control or assist in the longitudinal movement of the vehicle (e.g., acceleration, speed control, or braking, among other examples), lateral movement of the vehicle, or a combination. Artificial intelligence or machine learning (AI/ML) planning is an active area of research for autonomous vehicles. Some examples of the techniques described herein may provide learning to jointly plan and produce time-varying constraints imposed by dynamic and static objects during the generation of the plan. For instance, one or more constraints may be determined based on ground truth data, where the one or more constraints may be utilized to train an AI/ML model to predict one or more constraints at runtime. Constraints predicted by the AI/ML model may be utilized to control vehicle motion.

### CROSS REFERENCE

The present Application for Patent claims benefit of U.S. Provisional Patent Application No. 63/806,561 by SHAFFER et al., entitled “PREDICTED CONSTRAINTS FOR VEHICLE CONTROL,” filed May 15, 2025, assigned to the assignee hereof, and expressly incorporated herein.

### TECHNICAL FIELD

This disclosure relates generally to wireless communication, and more specifically to systems, devices, methods, and techniques associated with predicted constraints for vehicle control.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method by a device is described. The method may include obtaining data indicative of one or more environmental characteristics relative to a vehicle, determining, via input of the data to an artificial intelligence or machine learning (AI/ML) model, a predicted trajectory of the vehicle and one or more predicted constraints for vehicle control, determining a trajectory for control of the vehicle based on the predicted trajectory and the one or more predicted constraints, and controlling the vehicle based on the trajectory.

A device is described. The device may include one or more memory and one or more processors electronically coupled to the one or more memory. The one or more processors may be configured to obtain data indicative of one or more environmental characteristics relative to a vehicle, determine, via input of the data to an AI/ML, a predicted trajectory of the vehicle and one or more predicted constraints for vehicle control, determine a trajectory for control of the vehicle based on the predicted trajectory and the one or more predicted constraints, and control the vehicle based on the trajectory.

Another device is described. The device may include means for obtaining data indicative of one or more environmental characteristics relative to a vehicle, means for determining, via input of the data to an AI/ML, a predicted trajectory of the vehicle and one or more predicted constraints for vehicle control, means for determining a trajectory for control of the vehicle based on the predicted trajectory and the one or more predicted constraints, and means for controlling the vehicle based on the trajectory.

A non-transitory computer-readable medium storing code is described. The code may include instructions executable by one or more processors to obtain data indicative of one or more environmental characteristics relative to a vehicle, determine, via input of the data to an AI/ML, a predicted trajectory of the vehicle and one or more predicted constraints for vehicle control, determine a trajectory for control of the vehicle based on the predicted trajectory and the one or more predicted constraints, and control the vehicle based on the trajectory.

In some examples of the method, devices, and non-transitory computer-readable medium described herein, the trajectory for control of the vehicle may be determined without one or more predicted travel paths for one or more objects in a vicinity of the vehicle.

In some examples of the method, devices, and non-transitory computer-readable medium described herein, the AI/ML model may be trained to output the one or more predicted constraints based on one or more ground truth constraints obtained from training data.

In some examples of the method, devices, and non-transitory computer-readable medium described herein, a cost function for training the AI/ML model may be based on the one or more ground truth constraints obtained from training data.

In some examples of the method, devices, and non-transitory computer-readable medium described herein, the one or more ground truth constraints include, for one or more time instances of the training data, detection information of one or more objects within a distance from an ego vehicle, first identification information of a lead vehicle that may be situated in front of an ego vehicle, second identification information of a rear vehicle that may be situated behind an ego vehicle, frontal distance information indicating a distance between an ego vehicle and a lead vehicle that may be situated in front of an ego vehicle, rear distance information indicating a distance between an ego vehicle and a rear vehicle that may be situated behind an ego vehicle, left distance information indicating a distance between an ego vehicle and an object that may be situated to a left side of an ego vehicle, right distance information indicating a distance between an ego vehicle and an object that may be situated to a right side of an ego vehicle, or any combination thereof.

In some examples of the method, devices, and non-transitory computer-readable medium described herein, the one or more predicted constraints include, for one or more future time instances, detection information of one or more objects within a distance from the vehicle, first identification information of a lead vehicle that may be situated in front of the vehicle, second identification information of a rear vehicle that may be situated behind the vehicle, frontal distance information indicating a distance between the vehicle and a lead vehicle that may be situated in front of the vehicle, rear distance information indicating a distance between the vehicle and a rear vehicle that may be situated behind the vehicle, left distance information indicating a distance between the vehicle and an object that may be situated to a left side of the vehicle, right distance information indicating a distance between the vehicle and an object that may be situated to a right side of the vehicle, or any combination thereof.

A method by a device is described. The method may include obtaining training data indicative of trajectory information of an ego vehicle and environmental information indicative of one or more environmental characteristics relative to an ego vehicle, determining one or more ground truth constraints based on the training data, and training an AI/ML to output a predicted trajectory of the ego vehicle and one or more predicted constraints for ego vehicle control, where training the AI/ML model is based on an input of the environmental information to the AI/ML model and is in accordance with a cost function that is based on the one or more ground truth constraints.

A device is described. The device may include one or more memory and one or more processors electronically coupled to the one or more memory. The one or more processors may be configured to obtain training data indicative of trajectory information of an ego vehicle and environmental information indicative of one or more environmental characteristics relative to an ego vehicle, determine one or more ground truth constraints based on the training data, and train an AI/ML to output a predicted trajectory of the ego vehicle and one or more predicted constraints for ego vehicle control, where training the AI/ML model is based on an input of the environmental information to the AI/ML model and is in accordance with a cost function that is based on the one or more ground truth constraints.

Another device is described. The device may include means for obtaining training data indicative of trajectory information of an ego vehicle and environmental information indicative of one or more environmental characteristics relative to an ego vehicle, means for determining one or more ground truth constraints based on the training data, and means for training an AI/ML to output a predicted trajectory of the ego vehicle and one or more predicted constraints for ego vehicle control, where training the AI/ML model is based on an input of the environmental information to the AI/ML model and is in accordance with a cost function that is based on the one or more ground truth constraints.

A non-transitory computer-readable medium storing code is described. The code may include instructions executable by one or more processors to obtain training data indicative of trajectory information of an ego vehicle and environmental information indicative of one or more environmental characteristics relative to an ego vehicle, determine one or more ground truth constraints based on the training data, and train an AI/ML to output a predicted trajectory of the ego vehicle and one or more predicted constraints for ego vehicle control, where training the AI/ML model is based on an input of the environmental information to the AI/ML model and is in accordance with a cost function that is based on the one or more ground truth constraints.

Some examples of the method, devices, and non-transitory computer-readable medium described herein may further include operations, features, means, or instructions for training the AI/ML model may be performed without one or more predicted travel paths for one or more objects in a vicinity of the ego vehicle.

In some examples of the method, devices, and non-transitory computer-readable medium described herein, the one or more ground truth constraints include, for one or more time instances of the training data, detection information of one or more objects within a distance from an ego vehicle, first identification information of a lead vehicle that may be situated in front of an ego vehicle, second identification information of a rear vehicle that may be situated behind an ego vehicle, frontal distance information indicating a distance between an ego vehicle and a lead vehicle that may be situated in front of an ego vehicle, rear distance information indicating a distance between an ego vehicle and a rear vehicle that may be situated behind an ego vehicle, left distance information indicating a distance between an ego vehicle and an object that may be situated to a left side of an ego vehicle, right distance information indicating a distance between an ego vehicle and an object that may be situated to a right side of an ego vehicle, or any combination thereof.

### BRIEF DESCRIPTION OF THE DRAWINGS

FIG. 1 shows an example of a block diagram of a vehicle that supports predicted constraints for vehicle control.

FIG. 2 shows an example of a block diagram that supports predicted constraints for vehicle control.

FIG. 3 shows examples of diagrams that support predicted constraints for vehicle control.

FIG. 4 shows examples of diagrams that support predicted constraints for vehicle control.

FIG. 5 shows a block diagram of a processing system that supports predicted constraints for vehicle control.

FIG. 6 shows a diagram of a system including a device that supports predicted constraints for vehicle control.

FIGS. 7 and 8 show flowcharts illustrating methods that support predicted constraints for vehicle control.

Details of aspects and advantages of the subject matter in this disclosure are set forth in the drawings and accompanying descriptions. Like reference numbers and designations in the various drawings indicate like elements.

### DETAILED DESCRIPTION

Some vehicles utilize an autonomous driving system or advanced driver assistance system (ADAS) to provide automated driving functionality. When active, autonomous driving or ADAS may control or assist in the longitudinal movement of the vehicle (e.g., acceleration, speed control, or braking, among other examples), lateral movement of the vehicle, or a combination. Artificial intelligence or machine learning (AI/ML) planning is an active area of research for autonomous vehicles. For real-world products, outputs of AI motion plans (e.g., in the forms of trajectories) may be refined either in a post processing stage using trajectory refining techniques (e.g., motion predictive control (MPC) or linear quadratic regulator (LQR), among other examples) or may be passed directly to a controller that performs one or more operations similar to trajectory refining techniques. In some approaches, predictions of other vehicles are used to define a drivable space for the ego vehicle (e.g., the vehicle under control) when planning. Predictions may be used to create constraints on a trajectory formulation. For example, an AI planner may output a planned trajectory, where the output trajectory is assumed to have encoded other vehicle reactions (for joint planning and prediction, for instance). In some approaches, an AI planner may not produce predictions (e.g., unless specifically generated at the cost of complexity or run time).

Some examples of the techniques described herein may provide learning to jointly plan and produce time-varying constraints imposed by dynamic and static objects during the generation of the plan. For instance, one or more constraints may be determined based on ground truth data, where the one or more constraints may be utilized to train an AI/ML model to predict one or more constraints at runtime. Accordingly, predicting trajectories of other vehicles in the vicinity of the ego vehicle during runtime for the generation of constraints (e.g., which may be based on predicted trajectories of the ego vehicle in combination with the predicted trajectories of other vehicles) may be reduced or avoided. Constraints predicted by the AI/ML model may be utilized to control vehicle motion. Accordingly, runtime complexity, energy consumption, or latency may be reduced. Additionally, or alternatively, autonomous or assisted driving control responsiveness or efficiency may be increased.

As used herein, the term “component” may refer to a part of a device or system, or may refer to electronic hardware (e.g., circuitry), a combination of hardware (e.g., a processor) and instructions, mechanical hardware, or any combination thereof. For example, a component may refer to instructions executed by a processor, a controller, circuitry, a field-programmable gate array (FPGA), an application-specific integrated circuit (ASIC), a computing device, a mechanical actuator, or a mechanical actuator controlled by an electronic controller or processor, among other examples. In some aspects, one or more components may be localized to one processor or controller, or may be distributed between two or more processors or controllers. In some approaches, a component may include one or more computer readable media with one or more data structures or instructions stored thereon. In some examples, components may communicate electronically via wired or wireless signaling. For example, components may communicate via a wire, a bus, or a communication interface using one or more communication protocols (e.g., inter-integrated circuit (I2C), serial peripheral interface (SPI), universal serial bus (USB), Ethernet, Bluetooth, Institute of Electrical and Electronics Engineers (IEEE) 802.11 (e.g., “Wi-Fi”), cellular (e.g., 3G, 4G, long-term evolution (LTE), 5G, or 6G), or another protocol(s)).

As used herein, the term “vehicle” may refer to a machine for transportation that may be controlled by an operator, that may be autonomously controlled, or that may provide an operator with driving assistance (e.g., via an autonomous or semi-autonomous vehicle control system). For instance, a “vehicle” may refer to an automobile, a recreational vehicle, a boat, a ship, an airplane, or other vehicle.

As used herein, the term “operator” may refer to an individual that may operate (e.g., control) a vehicle. An operator may be a driver of an automobile, a captain or pilot of a boat, a captain or pilot of an airplane, or other vehicle operator.

As used herein, the terms “automated vehicle control” or “autonomous vehicle control” may refer to automated or autonomous vehicle control that may control one or more aspects (e.g., steering, braking, or acceleration, among other examples) of a vehicle without operator input or in addition to operator input.

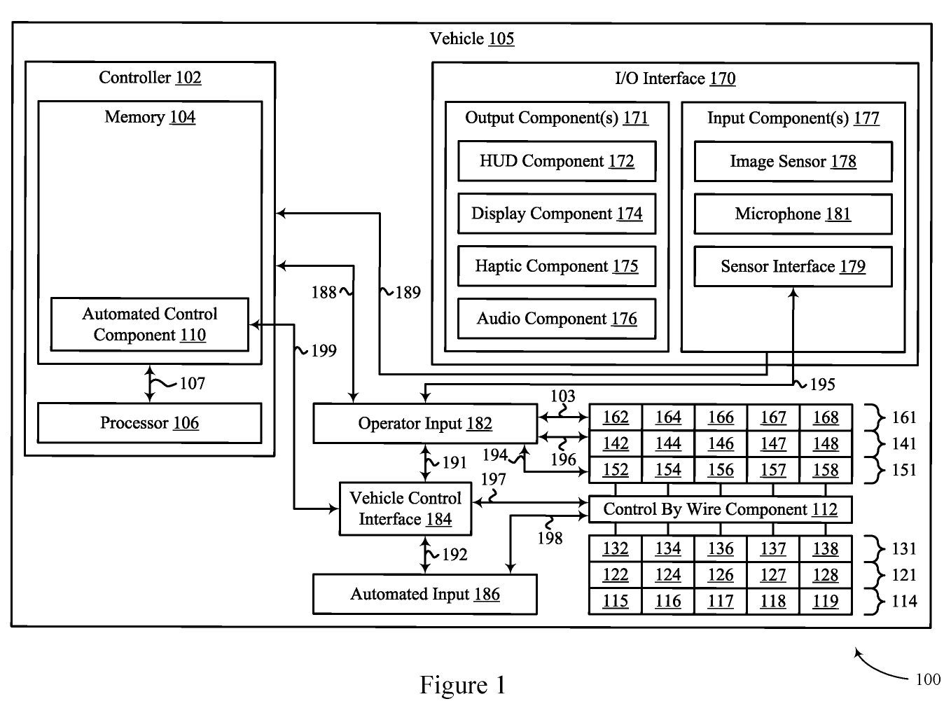

FIG. 1 shows an example of a block diagram 100 of a vehicle 105 that supports predicted constraints for vehicle control. In some examples, the vehicle 105 may include an controller 102 and an input or output (I/O) interface 170. In some approaches, the controller 102 may include a processor 106 coupled with a memory 104 via a system bus 107. The processor 106 may be a general purpose processor or a special purpose processor configured to execute instructions stored in the memory 104. Additionally, or alternatively, the processor 106 may include on-board memory. In some examples, the processor 106 may include multiple processors that may perform one or more operations jointly or independently.

In some aspects, the memory 104 may store executable instructions. For instance, the memory 104 may include instructions for (e.g., to implement) an automated control component 110. For instance, the automated control component 110 may be implemented with instructions executed by the processor 106. Additionally, or alternatively, the automated control component 110 may be implemented in hardware (e.g., circuitry, an FPGA, or an ASIC, among other examples), independently from the memory 104 or the processor 106. In some approaches, the automated control component 110 may perform one or more of the operations described herein. In some examples, the controller 102, the memory 104, the processor 106, or any combination thereof may be a processing system or may be referred to as a processing system.

In some approaches, the I/O interface 170 may include one or more output components 171 configured to output information (to an operator of the vehicle 105, for instance). Additionally, or alternatively, the I/O interface 170 may include one or more input components 177 configured to obtain (e.g., receive) or provide input information to the controller 102. For example, the output component(s) 171 may include a heads up display (HUD) component 172, a display component 174, a haptic component 175, or an audio component 176. The HUD component 172 may be configured to display, project or otherwise output visual information (e.g., image(s) or video), which may be provided to an operator of the vehicle 105.

In some examples, the display component 174 may include one or more electronic elements (e.g., a liquid crystal display (LCD) panel, an organic light emitting display (OLED) panel, an e-ink panel, or a screen, among other examples) for providing (e.g., outputting) a visual signal (e.g., image(s), video, or other visual information). Additionally, or alternatively, the audio component 176 may include one or more electronic elements (e.g., one or more speakers or horns, among other examples) for providing (e.g., outputting) an audio signal (e.g., sounds, tones, a speech signal, or other audio information).

In some approaches, the input component(s) 177 may include one or more sensors for obtaining data (e.g., data indicative of one or more environmental (e.g., external) characteristics or internal characteristics relative to the vehicle 105). For instance, the input component(s) 177 may include image sensors 178 (e.g., camera(s)), one or more microphones 181, or a sensor interface 179. In some examples, the image sensor(s) 178 may include one or more still or video cameras. The image sensor(s) 178 may capture light information (e.g., images of an external environment of the vehicle 105 such as a road or other object(s), one or more images of a vehicle occupant(s), such as an operator of the vehicle 105) and may communicate the light information to the controller 102. The microphone(s) 181 may capture acoustic information (e.g., sound signals or one or more sounds from a vehicle occupant(s), such as an operator of the vehicle 105, sound signals or one or more sounds from the exterior of the vehicle, 105, or a combination thereof) and may communicate the acoustic information to the controller 102. One or more additional sensors may be utilized (e.g., included in the I/O interface 170) to capture data relative to the vehicle 105, such as a light detection and ranging (LIDAR) sensor(s), time-of-flight (ToF) camera(s), depth sensor(s), proximity sensor(s), accelerometer(s), motion sensor(s), or orientation sensor(s), among other examples. In some approaches, the sensor interface 179 may be configured to receive information from one or more sensors of the vehicle 105 and communicate the state of the sensors to the controller 102. For instance, the sensor interface 179 may receive information from one or more buttons, a touch screen, a safety belt sensor(s), door sensor(s), radio frequency (RF) sensor(s), accelerometer(s), motion sensor(s), or pressure sensor(s) (e.g., seat pressure sensor(s)), among other examples. Additionally, or alternatively, the sensor interface 179 may receive information regarding operator input from the operator input component 182 (e.g., via connection 195). The sensor interface 179 may provide the information regarding the operation input component 182 to the controller 102. In some aspects, the input component(s) 177 may provide input information 189 to the controller 102. The input information 189 may include information from the image sensor(s) 178, the microphone(s) 181, or the sensor interface 179.

The vehicle 105 may include vehicle systems 114 and vehicle controls 141. The vehicle systems 114 may include an accelerator 115, brake 116, steering 117, clutch 118, or one or more other systems 119. For instance, the accelerator 115 may include a powertrain of the vehicle 105 for propulsion. The brake 116 may include the braking system of the vehicle for slowing or stopping the vehicle 105.

One or more sensors 121 may be associated with one or more of the vehicle systems 114. For example, a sensor 122 may be associated with the accelerator 115, a sensor 124 may be associated with the brake 116, a sensor 126 may be associated with the steering 117, a sensor 127 may be associated with the clutch 118, or a sensor 128 may be associated with the one or more other systems 119. One or more of the sensors 121 may be configured to detect or communicate a state of a respective vehicle system to a control by wire component 112 (e.g., a “drive by wire” system for an automobile). The control by wire component 112 may receive electronic control inputs from one or more vehicle controls. In some examples, the control by wire component 112 may provide one or more signals to operate one or more of the vehicle systems 114 via one or more actuators 131. For example, an actuator 132 may be associated with the sensor 122 or the accelerator 115. In some approaches, the actuator 132 may receive a control signal from the control by wire component 112 and may provide a signal that causes the accelerator 115 to control the speed of the vehicle 105. The sensor 122 may monitor the vehicle system (e.g., the accelerator 115) or the actuator 132, and may provide information to the sensor interface 179.

In some examples, an actuator 134 may be associated with the sensor 124 or the brake 116. In some aspects, the actuator 134 may receive a control signal from the control by wire component 112, and may provide a signal that causes the brake 116 to engage or disengage (e.g., to slow the vehicle 105 or allow the vehicle 105 to move). The sensor 124 may monitor the vehicle system (e.g., the brake 116) or the actuator 134, and may provide information to the sensor interface 179.

In some aspects, an actuator 136 may be associated with the sensor 126 or the steering 117. In some examples, the actuator 136 may receive a control signal from the control by wire component 112 and may provide a signal that causes the steering 117 to control the direction (e.g., lateral direction) of the vehicle 105. The sensor 126 may monitor the vehicle system (e.g., the steering 117) or the actuator 136, and may provide information to the sensor interface 179. In some examples, the actuator 136 or the actuator 166 may be coupled to, or associated with, a steering structure 146 (e.g., a steering wheel, steering column, another steering mechanism, or a combination thereof). The actuator 136 or the actuator 166 may apply (e.g., impart) a torque on the steering structure 146. The torque applied to the steering structure 146 may be associated with an amount of steering 117 performed.

In some approaches, an actuator 137 may be associated with the sensor 127 or the clutch 118. In some examples, the actuator 137 may receive a control signal from the control by wire component 112 and may provide a signal that causes the clutch 118 to engage or disengage drive power to the vehicle 105. The sensor 127 may monitor the vehicle system (e.g., the clutch 118) or the actuator 137, and may provide information to the sensor interface 179. In some examples, an actuator 138 may be associated with one or more other sensors 128 or one or more other systems 119.

The vehicle controls 141 may be coupled with the control by wire component 112 or the sensors 151. The vehicle controls 141 may be control systems that receive control inputs from an operator. For instance, the accelerator 142 may include an accelerator pedal of the vehicle 105 that is configured to be operated by an operator’s foot.

In some examples, the brake control 144 may include a brake pedal of the vehicle 105 that is configured to be operated by an operator’s foot. Additionally, or alternatively, the steering structure 146 may be a steering wheel of the vehicle 105 that is configured to be operated by an operator’s hands; the clutch control 147 may include a clutch pedal of the vehicle 105 that is configured to be operated by an operator’s foot; or one or more other controls 148 may include one or more other vehicle controls.

A sensor 152 may be associated with the accelerator 142, a sensor 154 may be associated with the brake control 144, a sensor 156 may be associated with the steering structure 146, a sensor 157 may be associated with the clutch control 147, or one or more sensors 158 may be associated with one or more other controls 148. The sensors 151 may provide a respective control input to the control by wire component to translate the operator-provided vehicle controls to the actual vehicle systems 114.

One or more actuators 161 may be associated with one or more respective vehicle controls 141. An actuator 162 may be associated with the accelerator 142, an actuator 164 may be associated with the brake control 144, an actuator 166 may be associated with the steering structure 146, an actuator 167 may be associated with a clutch control 147, or one or more other actuators 168 may be associated with one or more other controls 148. The actuators 161 may be utilized to actuate one or more of the vehicle controls 141. For instance, one or more of the actuators 161 may provide mechanical feedback or tuning to one or more of the vehicle controls 141, which may control the stiffness or softness of the vehicle control(s) 141. For instance, the actuator 166 may impart a torque to the steering structure 146, which may affect a quantity of force (e.g., stiffness or softness) of the steering structure 146 for steering the vehicle 105. In some approaches, the actuator(s) 161 may be coupled with the operator input component 182 (e.g., via connection 103). For instance, the actuator(s) 161 may be controlled by the operator input component 182 (or by the vehicle control interface 184, the automated input component 186, or the automated control component 110 via the operator input component 182).

In some examples, the vehicle 105 may include one or more mechanisms for controlling the vehicle 105 in addition to, or alternatively from, the control by wire component 112. For instance, the steering structure 146 may be mechanically coupled (via a steering column, for instance) with a rack and pinion mechanism for steering the vehicle 105. The actuator 136 may operate in conjunction with the steering column, steering wheel, or rack and pinion mechanism to steer the vehicle 105 when automated steering is active. In some examples, one or more actuators 131 may additionally, or alternatively, operate with one or more mechanisms in addition to, or alternatively from, the control by wire component 112. In some examples, the vehicle 105 may not include a control by wire component 112, and may utilize direct mechanical couplings to control one or more of the vehicle systems 114.

The vehicle 105 may include an operator input component 182, a vehicle control interface 184, or an automated input component 186. In some aspects, the operator input component 182 may represent one or more manual operator inputs provided to the vehicle 105 when the vehicle is under manual operator control, or when the vehicle may be under autonomous control and manual operator inputs are being compared with the autonomous control inputs to determine whether to transition to or from an autonomous driving state (e.g., automated steering). The operator input component 182 may be coupled with the vehicle controls 141 (e.g., via a connection 196), may be coupled with the sensor(s) 151 (e.g., via a connection 194), or may be coupled with the controller 102 (e.g., via a connection 188). In some examples, the sensor(s) 151 may receive one or more respective inputs from the operator input component 182 or may provide an output to the sensor interface 179.

The vehicle control interface 184 may be coupled with the control by wire component 112 (e.g., via connection 197), may be coupled with the operator input component 182 (e.g., via connection 191), or may be coupled with the automated input component 186 (e.g., via connection 192). The vehicle control interface 184 may be operatively coupled with the automated control component 110 (e.g., via connection 199).

When the vehicle 105 may be operating in an automated mode (e.g., when automated steering is active), the automated control component 110 may control the vehicle 105 by sending control signaling to the vehicle control interface 184. The vehicle control interface 184 may provide control signaling to the control by wire component 112. The control by wire component 112 may provide one or more inputs to the vehicle system(s) 114, to the actuator(s) 131, or to the sensor(s) 121 to operate the vehicle 105. The automated input component 186 may monitor the control by wire component 112 (e.g., via connection 198), or may provide information regarding vehicle operations or performance (e.g., via connection 192) to the vehicle control interface 184. The vehicle control interface 184 may provide corresponding information (e.g., via connection 199) to the automated control component 110.

Some vehicles utilize an autonomous driving system or ADAS to provide automated driving functionality. When active, autonomous driving or ADAS may control or assist in the longitudinal movement of the vehicle (e.g., acceleration, speed control, or braking, among other examples), lateral movement of the vehicle, or a combination. AI/ML planning is an active area of research for autonomous or assisted vehicles. For real-world products, outputs of AI motion plans (e.g., in the forms of trajectories) may be refined either in a post processing stage using trajectory refining techniques (e.g., MPC or LQR, among other examples) or may be passed directly to a controller that performs one or more operations similar to trajectory refining techniques. In some approaches, predictions of other vehicles are used to define a drivable space for the ego vehicle (e.g., the vehicle under control) when planning. Predictions may be used to create constraints on a trajectory formulation. For example, an AI planner may output a planned trajectory, where the output trajectory is assumed to have encoded other vehicle reactions (for joint planning and prediction, for instance).

Some examples of the techniques described herein may provide learning to jointly plan and produce time-varying constraints imposed by dynamic and static objects during the generation of the plan. For instance, one or more constraints may be determined based on ground truth data, where the one or more constraints may be utilized to train an AI/ML model to predict one or more constraints at runtime. Accordingly, predicting trajectories of other vehicles in the vicinity of the vehicle 105 (e.g., ego vehicle) during runtime for the generation of constraints (e.g., which may be based on predicted trajectories of the vehicle 105 in combination with the predicted trajectories of other vehicles) may be reduced or avoided. Constraints predicted by the AI/ML model may be utilized to control vehicle motion. Accordingly, runtime complexity, energy consumption, or latency may be reduced. Additionally, or alternatively, autonomous or assisted driving control responsiveness or efficiency may be increased.

Some examples of the techniques described herein may involve predicting plan-conditioned, time-varying constraints for autonomous vehicle motion planning by extracting an ego vehicle’s ground truth trajectory and/or projecting dynamic and/or static objects onto this path to identify one or more constraining (e.g., most constraining) elements in longitudinal and/or lateral directions, which may be utilized in a network to enhance the interpretability and/or enhancement of AI-planned trajectories, which may reduce complexity for constraint generation and/or may reduce computational complexity for more human-like driving behavior.

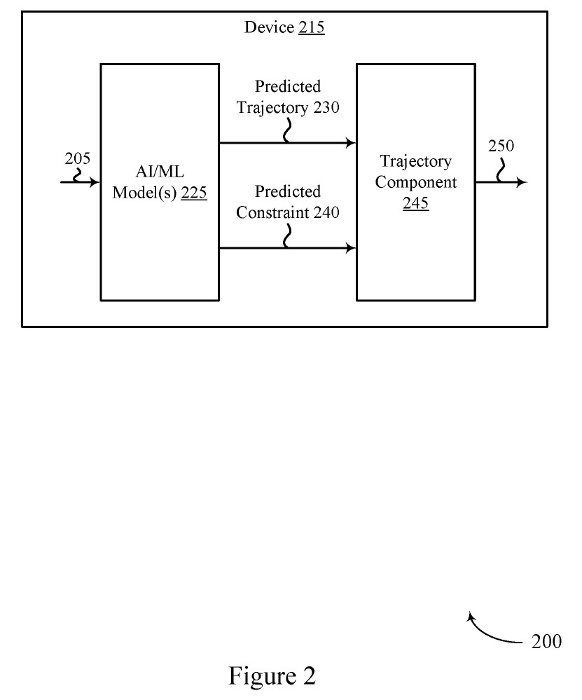

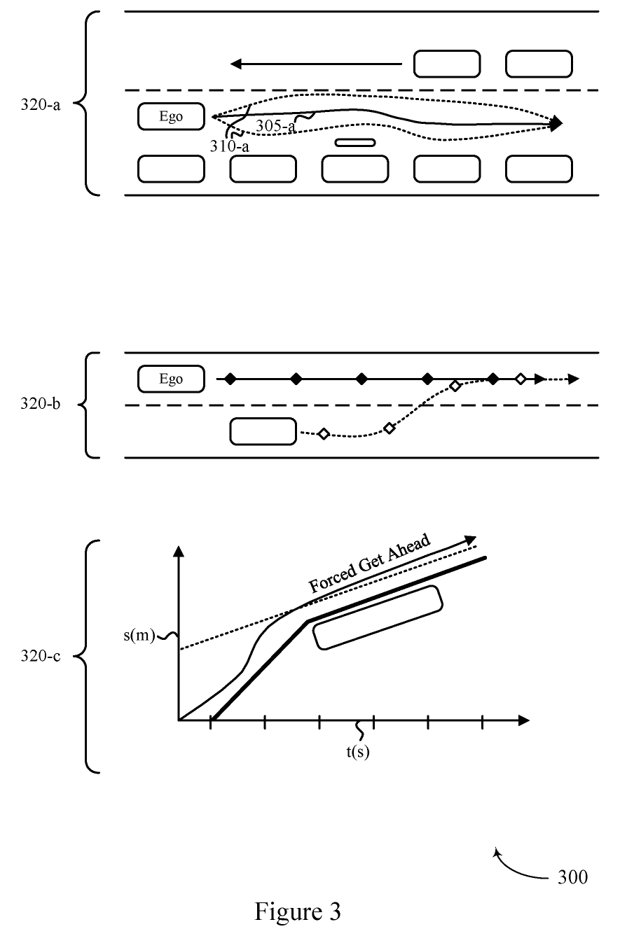

In some approaches, one or more AI/ML models may be stored in the memory 104 or included in the controller 102. For instance, one or more of the AI/ML models may be included in, or may interface with, the automated control component 110. The AI/ML model(s) may be trained or utilized to perform one or more of the techniques described with reference to one or more of FIGS. 2, 3, or 4.

FIG. 2 shows an example of a block diagram 200 that supports predicted constraints for vehicle control. In particular, FIG. 2 illustrates an example of a device 215. The device 215 may be implemented in hardware (e.g., circuitry) or in a combination of hardware and instructions (e.g., a processor with instructions). The device 215 may be an example of one or more elements or components described with reference to FIG. 1. For instance, the device 215 may be an example of the controller 102, or the controller 102 may be example of the device 215. In some approaches, the device 215 may be an example of the vehicle 105, may be included in the vehicle 105, or may be coupled with the vehicle 105. In some aspects, the device 215 may be an electronic control unit (ECU), may include an ECU, may be an on-board unit (OBU), or may include an OBU, among other examples. In some examples, the device 215 may be a processing system, may include a processing system, or may be included in a processing system. Additionally, or alternatively, the AI/ML model(s) 225 or the trajectory component 245 may be included in, or implemented by, a processing system in some approaches.

The device 215 (e.g., components of the device 215) may include one or more AI/ML models 225 or a trajectory component 245. One or more components of the device 215 may be implemented in hardware (e.g., circuitry) or in a combination of hardware and instructions (e.g., a processor with instructions).

The device 215 may obtain data 205 indicative of one or more environmental characteristics relative to a vehicle. For instance, the data 205 may include one or more sensor outputs or measurements (e.g., one or more images, distances, times, depths, motions, speeds, velocities, accelerations, temperatures, atmospheric moisture, or barometric pressure, among other examples) that indicate one or more environmental characteristics. Examples of environmental characteristics may include an object(s), object position(s), detected object(s), obstruction(s), vehicle(s), road marker(s), lane marker(s), sign(s), traffic control device(s), pedestrian(s), distance(s) to object(s), or weather condition(s), among other examples. In some approaches, the data 205 may include one or more encoded values indicating the one or more environmental characteristics.

The device 215 may determine, via input of the data 205 to the AI/ML model(s) 225, a predicted trajectory(ies) 230 of the vehicle and predicted constraint(s) 240 for vehicle control. For instance, an AI/ML model 225 may predict (e.g., infer) a predicted trajectory 230 of the vehicle (e.g., ego vehicle, vehicle 105) and a predicted constraint 240. As used herein, the term “predict” and variations thereof may refer to a past event(s), a current event(s), or a future event(s). For instance, the predicted trajectory(ies) 230 may indicate a direction(s), path(s), or route(s) that the vehicle is planned to follow at one or more future times. The predicted constraint(s) 240 may include or indicate one or more conditions, limitations, or ranges of operation for the vehicle to follow (e.g., allowed). Examples of constraints may include a longitudinal constraint(s). For instance, the longitudinal constraint(s) may include a vehicle dynamic constraint(s) related to the vehicle (e.g., a maximum or minimum speed, acceleration, or jerk), a position constraint(s) (e.g., a station versus time representation), or a combination thereof. Additionally, or alternatively, examples of constraints may include a lateral constraint(s). For instance, the lateral constraint(s) may include a lateral dynamic constraint(s) related to the vehicle (e.g., a maximum or minimum lateral acceleration or curvature), a position constraint(s) (e.g., lateral deviation versus time representation (multi-circle)), or a combination thereof. In some approaches, the AI/ML model(s) 225 may learn to jointly plan and produce the time-varying constraints imposed by dynamic and static objects during the generation of the plan.

In some examples, the predicted constraint(s) 240 may include, for one or more future time instances, detection information of one or more objects within a distance from the vehicle, first identification information of a lead vehicle that is situated in front of the vehicle, second identification information of a rear vehicle that is situated behind the vehicle, frontal distance information indicating a distance between the vehicle and a lead vehicle that is situated in front of the vehicle, rear distance information indicating a distance between the vehicle and a rear vehicle that is situated behind the vehicle, left distance information indicating a distance between the vehicle and an object that is situated to a left side of the vehicle, right distance information indicating a distance between the vehicle and an object that is situated to a right side of the vehicle, or any combination thereof.

The device 215 (e.g., trajectory component 245) may determine a trajectory 250 for control of the vehicle based on the predicted trajectory(ies) 230 and the predicted constraint(s) 240. For instance, the trajectory component 245 may perform MPC, LQR, or another technique(s) to determine the trajectory 250 based on the predicted trajectory(ies) 230 and the predicted constraint(s) 240. In some aspects, MPC may utilize one or more constraints (e.g., the predicted constraint(s) 240) during trajectory determination (or refinement) to balance physical quantities (e.g., safety or comfort, among other examples) or smoothness. MPC may be performed in two parts: longitudinal and lateral directions.

The device 215 may control the vehicle (e.g., ego vehicle or vehicle 105) based on the trajectory 250. For instance, the device 215 may control one or more actuators or devices to steer, accelerate, decelerate, or brake to control the vehicle based on the trajectory as described with reference to FIG. 1.

In some approaches, the trajectory 250 for control of the vehicle may be determined without one or more predicted travel paths for one or more objects in a vicinity of the vehicle. For instance, the device 215 may not predict, or may not utilize, one or more predicted travel paths for one or more objects (e.g., vehicle(s) or pedestrian(s)) to determine the trajectory 250.

In some examples, the AI/ML model 225 may be trained to output the predicted constraint(s) 240 based on one or more ground truth constraints obtained from training data. In some aspects, the constraints may include (e.g., may be simplified to) two directions: longitudinal and lateral constraints. With two directions each, the total quantity of outputs of the AI/ML model(s) 225 (e.g., network) may be four additional scalar values for each trajectory point, instead of (e.g., 8s, 6s, or full 4s, among other examples) horizon trajectories for all vehicles in an ego vehicle neighborhood. A horizon trajectory or trajectories may refer to a planning or prediction horizon of some ADAS or autonomous driving (AD) systems, where for each compute cycle (e.g., 10 hertz (Hz)) a trajectory (e.g., full trajectory) for the ego vehicle is planned or a trajectory is predicted for traffic vehicles for some horizon into the future. Using a ground truth, an ego planned trajectory may be extracted for training an AI motion planner. Along a multi-second horizon ground truth trajectory, for example, dynamic and static objects may be projected on to the path to determine lateral and longitudinal distances from the ego trajectory origin. The trajectory, object(s), or distance(s) may be filtered for constraining in both (e.g., two) directions, and may be set as the ground truth constraint values for a given time stamp of ego vehicle trajectory. In some aspects, the AI/ML model(s) 225 may learn one or more MPC constraints (e.g., longitudinal or lateral constraints may be learned for one or more objects). The ground truth extraction or constraint determination may be performed as a preprocessing stage of the training data (e.g., training set), where the AI/ML model(s) (e.g., network) is trained to produce the four values along with the trajectory either as elements of the planned trajectory or using a separate head for constraint decoding. The predicted, time-varying and ego plan conditioned constraints may be used for one or more purposes, such as interpretability or downstream trajectory refining.

In some approaches, a cost function for training the AI/ML model 225 may be based on the one or more ground truth constraints obtained from training data. During training, for instance, one or more predicted constraints of the AI/ML model(s) 225 may be compared with the ground truth constraints, where deviations of the predicted constraints from the ground truth constraints may be penalized via the cost function. In some approaches, the cost indicated by the cost function may be reduced or minimized during training.

In some examples, the one or more ground truth constraints may include, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

In some examples of the techniques described herein, the device 215 or another device (e.g., a server or one or more computing devices, among other examples), may train the AI/ML model(s) 225. For instance, a device (e.g., the device 215 or another device) may obtain training data indicative of trajectory information of an ego vehicle and environmental information indicative of one or more environmental characteristics relative to an ego vehicle. For instance, trajectory information indicating one or more trajectories of a vehicle driven by an operator may be obtained (e.g., sampled by the device 215 or received from another device). Additionally, or alternatively, environmental information (e.g., sensor data or labeled sensor data) indicative of one or environmental characteristics may be obtained.

The device may determine one or more ground truth constraints based on the training data. For instance, the device or another device (e.g., data pre-processor) may perform ground truth label extraction. In some examples, a data pre-processor may be utilized to extract a ground truth of constraints for a given trajectory. For one or more time instances (e.g., each frame), for example, the device may extract the next T seconds of an ego vehicle ground truth trajectory or path. One or more objects within a range (e.g., one or more neighboring objects or objects within a vicinity) may be detected or identified. In some approaches, a vehicle (e.g., an immediate lead vehicle) situated in front of the ego vehicle may be found (e.g., in image sensor data). A distance from the ego vehicle front bumper to the lead vehicle rear bumper may be determined or stored for the time instance (e.g., frame). Additionally, or alternatively, one or more distances from the ego vehicle sides to a constraining object(s) (e.g., in a lateral, perpendicular, or normal direction to the ego vehicle) may be determined or stored for the time instance (e.g., frame). When a ground truth trajectory is extracted for training, for example, the ground truth data (e.g., training data) may include a distance to an immediate lead vehicle, a distance to an immediate following vehicle, or one or more lateral boundaries from dynamic or static boundaries for each frame in the next T second trajectory (e.g., path).

The device may train the AI/ML model(s) 225 to output a predicted trajectory(ies) 230 of the ego vehicle and predicted constraint(s) 240 for ego vehicle control. Training the AI/ML model(s) 225 may be based on an input of the environmental information to the AI/ML model(s) 225 and may be in accordance with a cost function that is based on the one or more ground truth constraints. In some approaches, training the AI/ML model(s) 225 may be performed without one or more predicted travel paths for one or more objects in a vicinity (e.g., within a range) of the ego vehicle.

In some approaches, the one or more ground truth constraints may include, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

FIG. 3 show examples of diagrams 300 that support predicted constraints for vehicle control. In particular, FIG. 3 includes a first diagram 320-a illustrating an example of a planned trajectory 305-a of an ego vehicle and constraints 310-a in a lane of a road. FIG. 3 also includes a second diagram 320-b illustrating an example of a “cut in” scenario, where a predicted trajectory of a vehicle in an adjacent lane enters a lane of an ego vehicle. A third diagram 320-c is also shown, illustrating a “forced get ahead” action of an ego vehicle to avoid a collision with another vehicle. The third diagram 320-c is a graph illustrated a spatial or station dimension (in meters (m)) over time (in seconds). For example, s(m) as used herein may denote a station or arclength in meters, which may be a distance into a reference path for a longitudinal planning stage.

In some approaches to motion planning for autonomous vehicles, constraints may be derived from dynamic environment elements (e.g., stop-lines, traffic vehicles predictions, or pedestrians, among other examples) to formulate a trajectory (e.g., a refined trajectory) that increases (e.g., maximizes) smooth, safe, and human-like behavior. Some approaches may be limited in an ability to define a human-like objective (e.g., forced get ahead) across the entirety of the driving domain including complex interactions between traffic agents and the ego vehicle. To address these limitation, some approaches employ AI techniques to generate trajectories for the ego vehicle that are human-like and may consider interactive components inherent in driving on roads with humans. Some AI techniques have shown promise for imitating human driving given sufficient data and a capable AI architecture. However, tuning AI-predicted trajectories may be rule-based, preference-based, or strictly controllable properties at scale across many domains, which may demand a large amount of data and retraining. One approach may employ a version of trajectory refinement on the output of an AI planner with the objectives. One or more of the objective may be difficult to define and tune such that the trajectory refinement has sufficient freedom without contradicting the complex interactions evaluated during the AI planner generation. Some approaches may produce predictions for traffic agents in addition to an ego vehicle trajectory to include one or more constraints to the trajectory refinement to ensure that the refinement adheres to the planned mode. The addition of predictions may involve post processing the predictions into constraints, which may raise one or more relatively difficult issues. In some approaches, one or more constraints may be utilized for downstream improvement or control for AI planning. For instance, information about predictions of dynamic objects may be utilized. For example, vehicle prediction itself may be complex and computationally expensive.

Some examples of the techniques described herein may address some of the limitations of some of these approaches. For example, some examples of the techniques described herein may directly produce the constraints that specifically correspond to an AI planned trajectory. For instance, some examples of the techniques described herein may include predicting plan-conditioned time-varying control or refinement constraints in autonomous vehicle AI motion planning. In some approaches, instead of performing post processing (to determine constraints from predicted trajectories of one or more non-ego vehicle objects, such as pedestrians or other vehicles), some examples of the techniques (e.g., an AI/ML model) described may directly predict the constraints with the trajectory. In some examples, the trajectory and constraint prediction may be performed by a single AI/ML model or multiple AI/ML models. In some approaches of the techniques described herein, time-varying or multi-modal constraints may be predicted without complete dynamic object predictions (e.g., which may improve efficiency).

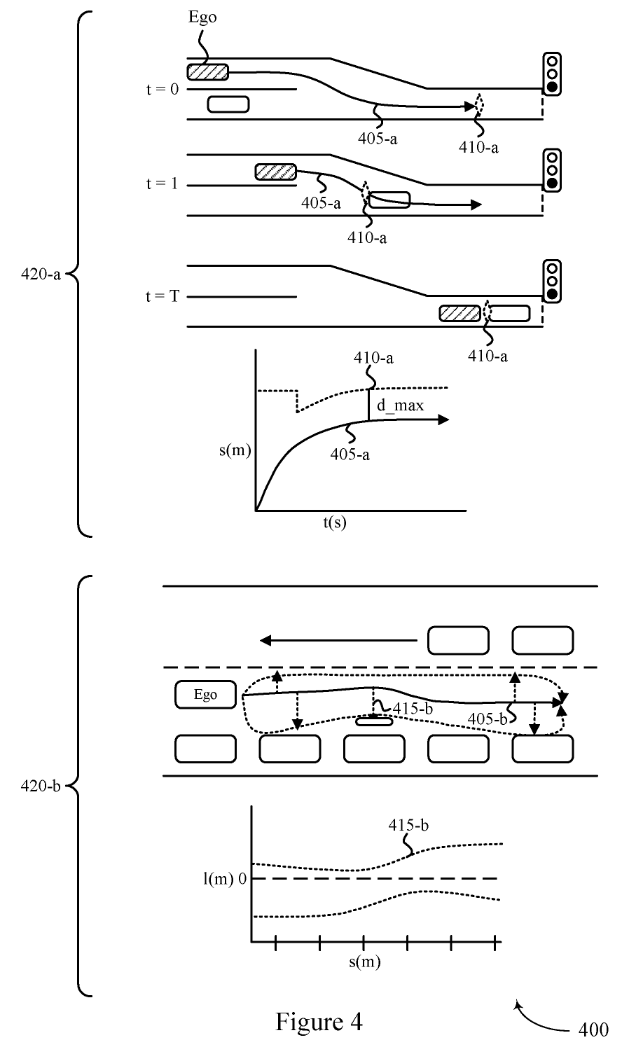

FIG. 4 shows examples of diagrams 400 that support predicted constraints for vehicle control. In particular, FIG. 4 includes a first diagram 420-a illustrating an example of a trajectory 405-a of an ego vehicle and a longitudinal constraint 410-a in a merging scenario on a road approaching a stoplight. As illustrated in the first diagram 420-a, a trajectory 405-a of an ego vehicle includes merging into a lane behind another vehicle. A graph is also shown in the first diagram 420-a that illustrates the trajectory 405-a (in a spatial or station dimension, such as a station or arclength, in meters over time in seconds). The longitudinal constraint 410-a may constrain the ego vehicle to move within no more than a distance (e.g., “d_max”) of the other vehicle. As described herein, a device (e.g., pre-processor) may extract a ground truth of the longitudinal constraint 410-a. For instance, the longitudinal constraint may be extracted as ground truth constraint data as a distance from the ego vehicle front bumper to a lead vehicle rear bumper for one or more time instances (e.g., frames). An AI/ML model may be trained to predict the longitudinal constraint during runtime (e.g., instead of predicting a trajectory of the other vehicle and extracting the constraint based on the predicted trajectory), which may reduce computational complexity or increase efficiency.

As illustrated in the second diagram 420-b, a trajectory 405-b of an ego vehicle includes staying in a lane and avoiding objects in a lateral direction from the ego vehicle. A graph is also shown in the second diagram 420-b that illustrates the lateral constraint 415-b (in a lateral dimension in meters over a spatial or station dimension in meters). For example, l(m) as used herein may denote a lateral deviation in meters from a reference path for planning lateral motion. The lateral constraint 415-b may constrain the ego vehicle to move within no more than a lateral distance of an object or a lane marker. As described herein, a device (e.g., pre-processor) may extract a ground truth of the lateral constraint 415-b. For instance, the lateral constraint may be extracted as ground truth constraint data as a distance from ego vehicle sides to a constraining object (e.g., nearest constraining object) normal to the ego vehicle for one or more time instances (e.g., frames). An AI/ML model may be trained to predict the lateral constraint during runtime (e.g., instead of predicting a trajectory of the other vehicle and extracting the constraint based on the predicted trajectory), which may reduce computational complexity or increase efficiency. Some examples of the techniques described herein may be performed in accordance with one or more equations, such as KP = (x, y, theta) or Future Traj = (x, y, theta, dmin, dmax) (e.g., for a “get ahead” reference trajectory). The dmin or dmax may correspond to one or more time instances. In some approaches, dmin may denote a distance (e.g., minimum distance) between a rear of the ego vehicle and a following vehicle. Additionally, or alternatively, dmax may denote a distance (e.g., maximum distance) between a front of the ego vehicle and a lead vehicle.

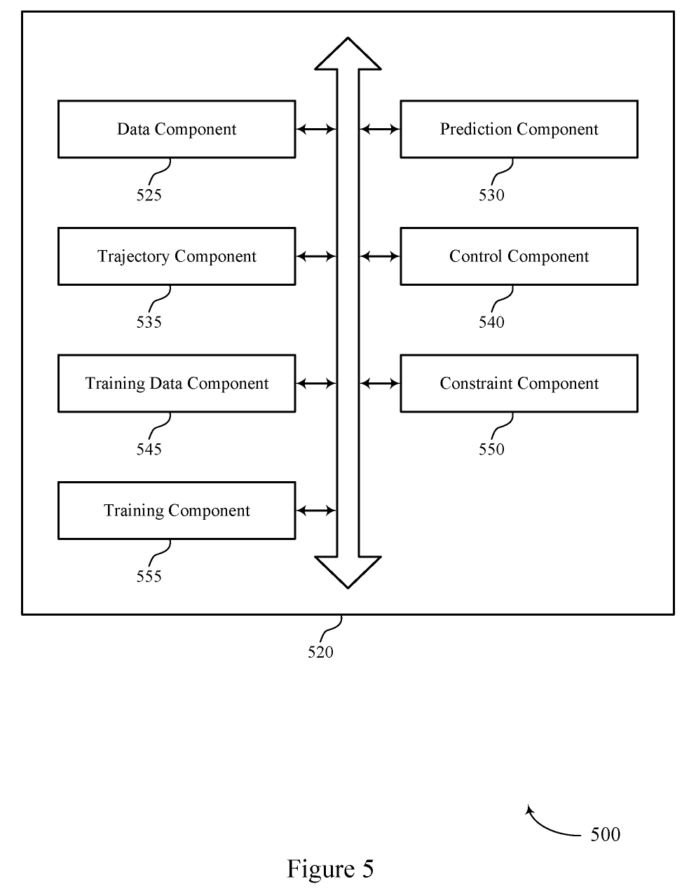

FIG. 5 shows a block diagram 500 of a processing system 520 that supports predicted constraints for vehicle control in accordance with one or more aspects of the present disclosure. The processing system 520 may be an example of aspects of a device (e.g., controller, vehicle, electronic device, or processing system) as described with reference to FIGS. 1-4. The processing system 520, or various components thereof, may be an example of means for performing (e.g., to cause the processing system 520 to perform) various aspects of predicted constraints for vehicle control as described herein. For example, the processing system 520 may include a data component 525, a prediction component 530, a trajectory component 535, a control component 540, a training data component 545, a constraint component 550, a training component 555, or any combination thereof. Each of these components, or components or subcomponents thereof (e.g., one or more processors, one or more memories), may communicate, directly or indirectly, with one another (e.g., via one or more buses).

The data component 525 is capable of, configured to, or operable to support a means for obtaining data indicative of one or more environmental characteristics relative to a vehicle. The prediction component 530 is capable of, configured to, or operable to support a means for determining, via input of the data to an AI/ML, a predicted trajectory of the vehicle and one or more predicted constraints for vehicle control. The trajectory component 535 is capable of, configured to, or operable to support a means for determining a trajectory for control of the vehicle based on the predicted trajectory and the one or more predicted constraints. The control component 540 is capable of, configured to, or operable to support a means for controlling the vehicle based on the trajectory.

In some examples, the trajectory for control of the vehicle is determined without one or more predicted travel paths for one or more objects in a vicinity of the vehicle.

In some examples, the AI/ML model is trained to output the one or more predicted constraints based on one or more ground truth constraints obtained from training data.

In some examples, a cost function for training the AI/ML model is based on the one or more ground truth constraints obtained from training data.

In some examples, the one or more ground truth constraints include, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

In some examples, the one or more predicted constraints include, for one or more future time instances, detection information of one or more objects within a distance from the vehicle, first identification information of a lead vehicle that is situated in front of the vehicle, second identification information of a rear vehicle that is situated behind the vehicle, frontal distance information indicating a distance between the vehicle and a lead vehicle that is situated in front of the vehicle, rear distance information indicating a distance between the vehicle and a rear vehicle that is situated behind the vehicle, left distance information indicating a distance between the vehicle and an object that is situated to a left side of the vehicle, right distance information indicating a distance between the vehicle and an object that is situated to a right side of the vehicle, or any combination thereof.

The training data component 545 is capable of, configured to, or operable to support a means for obtaining training data indicative of trajectory information of an ego vehicle and environmental information indicative of one or more environmental characteristics relative to an ego vehicle. The constraint component 550 is capable of, configured to, or operable to support a means for determining one or more ground truth constraints based on the training data. The training component 555 is capable of, configured to, or operable to support a means for training an AI/ML to output a predicted trajectory of the ego vehicle and one or more predicted constraints for ego vehicle control, where training the AI/ML model is based on an input of the environmental information to the AI/ML model and is in accordance with a cost function that is based on the one or more ground truth constraints.

In some examples, training the AI/ML model is performed without one or more predicted travel paths for one or more objects in a vicinity of the ego vehicle.

In some examples, the one or more ground truth constraints include, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

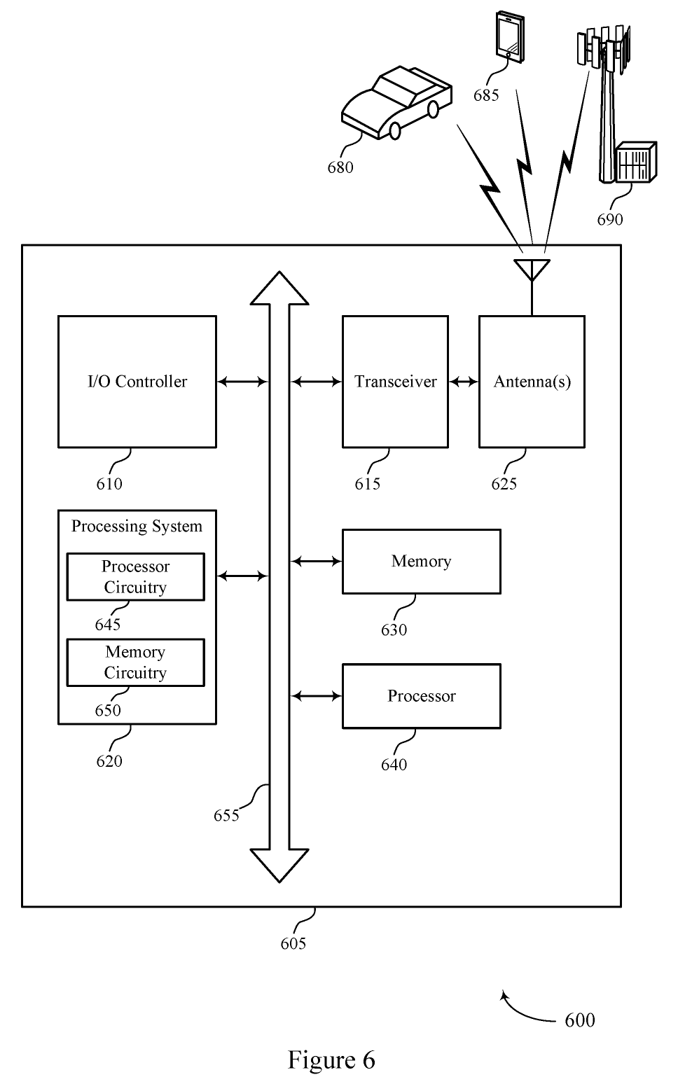

FIG. 6 shows an example of a system 600 including a device 605 that supports predicted constraints for vehicle control. The device 605 may include a processing system 620, an I/O controller, such as an I/O controller 610, a transceiver 615, one or more antennas 625, at least one memory 630, at least one processor 640, a processor circuitry 645, and a memory circuitry 650. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

In some cases, the device 605 may include a single antenna. However, in some other cases, the device 605 may have more than one antenna, which may be capable of concurrently transmitting or receiving multiple wireless transmissions. The transceiver 615 may communicate bi-directionally via the one or more antenna(s) 625 using wired or wireless links as described herein. For example, the transceiver 615 may represent a wireless transceiver and may communicate bi-directionally with another wireless transceiver. The transceiver 615 may also include a modem to modulate the packets, to provide the modulated packets to one or more antenna(s) 625 for transmission, and to demodulate packets received from the one or more antenna(s) 625. In some examples, the device may communicate with one or more other devices, such as a vehicle 680, a wireless device 685, or a base station 690 or another device(s) (e.g., roadside unit (RSU)).

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

For example, the processing system 620 is capable of, configured to, or operable to support a means for obtaining data indicative of one or more environmental characteristics relative to a vehicle. The processing system 620 is capable of, configured to, or operable to support a means for determining, via input of the data to an AI/ML, a predicted trajectory of the vehicle and one or more predicted constraints for vehicle control. The processing system 620 is capable of, configured to, or operable to support a means for determining a trajectory for control of the vehicle based on the predicted trajectory and the one or more predicted constraints. The processing system 620 is capable of, configured to, or operable to support a means for controlling the vehicle based on the trajectory.

For example, the processing system 620 is capable of, configured to, or operable to support a means for obtaining training data indicative of trajectory information of an ego vehicle and environmental information indicative of one or more environmental characteristics relative to an ego vehicle. The processing system 620 is capable of, configured to, or operable to support a means for determining one or more ground truth constraints based on the training data. The processing system 620 is capable of, configured to, or operable to support a means for training an AI/ML to output a predicted trajectory of the ego vehicle and one or more predicted constraints for ego vehicle control, where training the AI/ML model is based on an input of the environmental information to the AI/ML model and is in accordance with a cost function that is based on the one or more ground truth constraints.

By including or configuring the processing system 620 for operation in the device 605 as described herein, may support techniques for improved autonomous or assisted vehicle control, reduced latency, improved user experience related to reduced processing, reduced power consumption, more efficient utilization of computation resources, improved coordination between devices, longer battery life, or improved utilization of processing capability.

The processing system 620 may be an example of a controller 102, memory 104, processor 106, device 215, or a processing system 520. For example, the processing system 620 may include processor circuitry 645 and memory circuitry 650 that stores code, and may be configured to cause the device 605 to perform operations that support predicted constraints for vehicle control. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

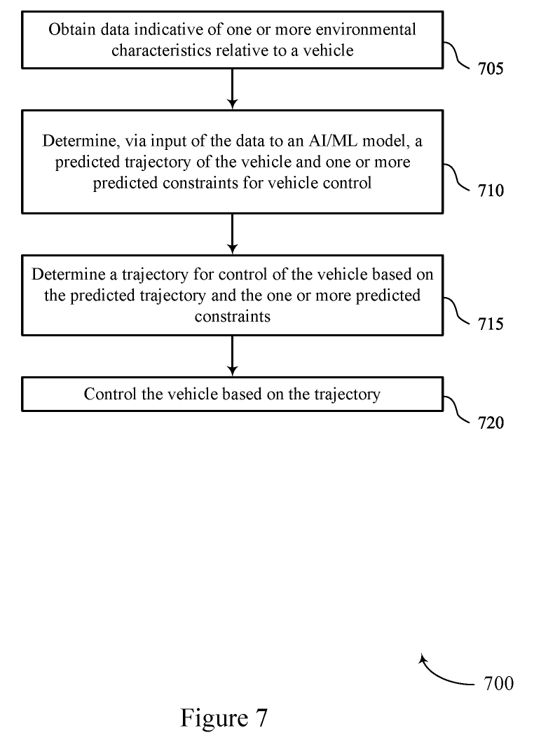

FIG. 7 shows a flowchart illustrating a method 700 that supports predicted constraints for vehicle control. The operations of the method 700 may be implemented by a device or its components as described herein. For example, the operations of the method 700 may be performed by a device as described with reference to FIGS. 1-6. In some examples, a device may execute a set of instructions to control the functional elements of the device to perform the described functions. Additionally, or alternatively, the device may perform aspects of the described functions using special-purpose hardware.

At 705, the method may include obtaining data indicative of one or more environmental characteristics relative to a vehicle. In some examples, aspects of the operations of 705 may be performed by a data component 525.

At 710, the method may include determining, via input of the data to an AI/ML, a predicted trajectory of the vehicle and one or more predicted constraints for vehicle control. In some examples, aspects of the operations of 710 may be performed by a prediction component 530.

At 715, the method may include determining a trajectory for control of the vehicle based on the predicted trajectory and the one or more predicted constraints. In some examples, aspects of the operations of 715 may be performed by a trajectory component 535.

At 720, the method may include controlling the vehicle based on the trajectory. In some examples, aspects of the operations of 720 may be performed by a control component 540.

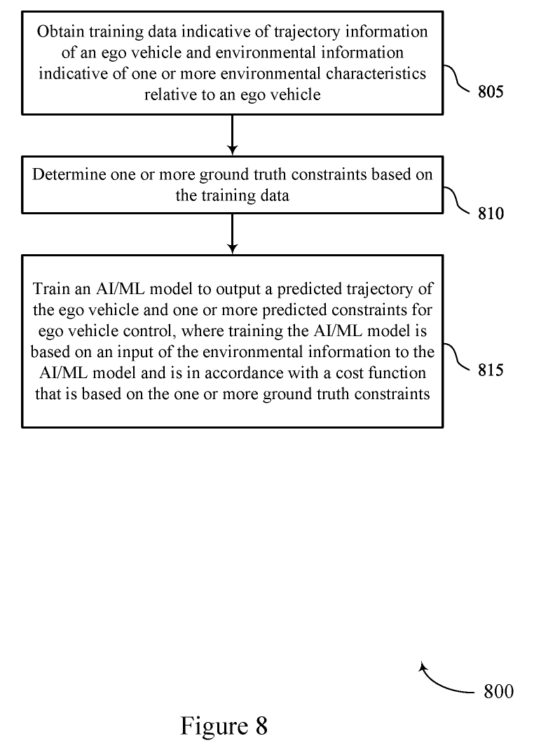

FIG. 8 shows a flowchart illustrating a method 800 that supports predicted constraints for vehicle control. The operations of the method 800 may be implemented by a device or its components as described herein. For example, the operations of the method 800 may be performed by a device as described with reference to FIGS. 1-6. In some examples, a device may execute a set of instructions to control the functional elements of the device to perform the described functions. Additionally, or alternatively, the device may perform aspects of the described functions using special-purpose hardware.

At 805, the method may include obtaining training data indicative of trajectory information of an ego vehicle and environmental information indicative of one or more environmental characteristics relative to an ego vehicle. In some examples, aspects of the operations of 805 may be performed by a training data component 545.

At 810, the method may include determining one or more ground truth constraints based on the training data. In some examples, aspects of the operations of 810 may be performed by a constraint component 550.

At 815, the method may include training an AI/ML to output a predicted trajectory of the ego vehicle and one or more predicted constraints for ego vehicle control, where training the AI/ML model is based on an input of the environmental information to the AI/ML model and is in accordance with a cost function that is based on the one or more ground truth constraints. In some examples, aspects of the operations of 815 may be performed by a training component 555.

Implementation examples are described in the following numbered clauses:

Aspect 1: A method for AI/ML at a device, comprising: obtaining data indicative of one or more environmental characteristics relative to a vehicle; determining, via input of the data to an AI/ML, a predicted trajectory of the vehicle and one or more predicted constraints for vehicle control; determining a trajectory for control of the vehicle based at least in part on the predicted trajectory and the one or more predicted constraints; and controlling the vehicle based at least in part on the trajectory.

Aspect 2: The method of aspect 1, wherein the trajectory for control of the vehicle is determined without one or more predicted travel paths for one or more objects in a vicinity of the vehicle.

Aspect 3: The method of any of aspects 1 through 2, wherein the AI/ML model is trained to output the one or more predicted constraints based at least in part on one or more ground truth constraints obtained from training data.

Aspect 4: The method of aspect 3, wherein a cost function for training the AI/ML model is based at least in part on the one or more ground truth constraints obtained from training data.

Aspect 5: The method of any of aspects 3 through 4, wherein the one or more ground truth constraints comprise, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

Aspect 6: The method of any of aspects 1 through 5, wherein the one or more predicted constraints comprise, for one or more future time instances, detection information of one or more objects within a distance from the vehicle, first identification information of a lead vehicle that is situated in front of the vehicle, second identification information of a rear vehicle that is situated behind the vehicle, frontal distance information indicating a distance between the vehicle and a lead vehicle that is situated in front of the vehicle, rear distance information indicating a distance between the vehicle and a rear vehicle that is situated behind the vehicle, left distance information indicating a distance between the vehicle and an object that is situated to a left side of the vehicle, right distance information indicating a distance between the vehicle and an object that is situated to a right side of the vehicle, or any combination thereof.

Aspect 7: A method for AI/ML at a device, comprising: obtaining training data indicative of trajectory information of an ego vehicle and environmental information indicative of one or more environmental characteristics relative to an ego vehicle; determining one or more ground truth constraints based at least in part on the training data; and training an AI/ML to output a predicted trajectory of the ego vehicle and one or more predicted constraints for ego vehicle control, wherein training the AI/ML model is based at least in part on an input of the environmental information to the AI/ML model and is in accordance with a cost function that is based at least in part on the one or more ground truth constraints.

Aspect 8: The method of aspect 7, wherein training the AI/ML model is performed without one or more predicted travel paths for one or more objects in a vicinity of the ego vehicle.

Aspect 9: The method of any of aspects 7 through 8, wherein the one or more ground truth constraints comprise, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

Aspect 10: A device comprising a processing system that includes processor circuitry and memory circuitry that stores code, the processing system configured to cause the device to perform a method of any of aspects 1 through 6.

Aspect 11: A device comprising at least one means for performing a method of any of aspects 1 through 6.

Aspect 12: A non-transitory computer-readable medium storing code the code comprising instructions executable by one or more processors to perform a method of any of aspects 1 through 6.

Aspect 13: A device comprising a processing system that includes processor circuitry and memory circuitry that stores code, the processing system configured to cause the device to perform a method of any of aspects 7 through 9.

Aspect 14: A device comprising at least one means for performing a method of any of aspects 7 through 9.

Aspect 15: A non-transitory computer-readable medium storing code the code comprising instructions executable by one or more processors to perform a method of any of aspects 7 through 9.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (e.g., a controller 102, processor 106, or device 215, among other examples) may include processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (e.g., a controller 102, processor 106, or device 215, among other examples) may also include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (e.g., a controller 102, processor 106, or device 215, among other examples) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A device, comprising:
one or more memory; and
one or more processors electronically coupled to the one or more memory, the one or more processors configured to:
obtain data indicative of one or more environmental characteristics relative to a vehicle;
determine, via input of the data to an artificial intelligence or machine learning (AI/ML) model, a predicted trajectory of the vehicle and one or more predicted constraints for vehicle control;
determine a trajectory for control of the vehicle based at least in part on the predicted trajectory and the one or more predicted constraints; and
control the vehicle based at least in part on the trajectory.

2. The device of claim 1, wherein the trajectory for control of the vehicle is determined without one or more predicted travel paths for one or more objects in a vicinity of the vehicle.

3. The device of claim 1, wherein the AI/ML model is trained to output the one or more predicted constraints based at least in part on one or more ground truth constraints obtained from training data.

4. The device of claim 3, wherein a cost function for training the AI/ML model is based at least in part on the one or more ground truth constraints obtained from training data.

5. The device of claim 3, wherein the one or more ground truth constraints comprise, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

6. The device of claim 1, wherein the one or more predicted constraints comprise, for one or more future time instances, detection information of one or more objects within a distance from the vehicle, first identification information of a lead vehicle that is situated in front of the vehicle, second identification information of a rear vehicle that is situated behind the vehicle, frontal distance information indicating a distance between the vehicle and a lead vehicle that is situated in front of the vehicle, rear distance information indicating a distance between the vehicle and a rear vehicle that is situated behind the vehicle, left distance information indicating a distance between the vehicle and an object that is situated to a left side of the vehicle, right distance information indicating a distance between the vehicle and an object that is situated to a right side of the vehicle, or any combination thereof.

7. A device, comprising:
one or more memory; and
one or more processors electronically coupled to the one or more memory, the one or more processors configured to:
obtain training data indicative of trajectory information of an ego vehicle and environmental information indicative of one or more environmental characteristics relative to an ego vehicle;
determine one or more ground truth constraints based at least in part on the training data; and
train an artificial intelligence or machine learning (AI/ML) model to output a predicted trajectory of the ego vehicle and one or more predicted constraints for ego vehicle control, wherein training the AI/ML model is based at least in part on an input of the environmental information to the AI/ML model and is in accordance with a cost function that is based at least in part on the one or more ground truth constraints.

8. The device of claim 7, wherein training the AI/ML model is performed without one or more predicted travel paths for one or more objects in a vicinity of the ego vehicle.

9. The device of claim 7, wherein the one or more ground truth constraints comprise, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

10. A method for artificial intelligence or machine learning (AI/ML) at a device, comprising:
obtaining data indicative of one or more environmental characteristics relative to a vehicle;
determining, via input of the data to an artificial intelligence or machine learning (AI/ML) model, a predicted trajectory of the vehicle and one or more predicted constraints for vehicle control;
determining a trajectory for control of the vehicle based at least in part on the predicted trajectory and the one or more predicted constraints; and
controlling the vehicle based at least in part on the trajectory.

11. The method of claim 10, wherein the trajectory for control of the vehicle is determined without one or more predicted travel paths for one or more objects in a vicinity of the vehicle.

12. The method of claim 10, wherein the AI/ML model is trained to output the one or more predicted constraints based at least in part on one or more ground truth constraints obtained from training data.

13. The method of claim 12, wherein a cost function for training the AI/ML model is based at least in part on the one or more ground truth constraints obtained from training data.

14. The method of claim 12, wherein the one or more ground truth constraints comprise, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.

15. The method of claim 10, wherein the one or more predicted constraints comprise, for one or more future time instances, detection information of one or more objects within a distance from the vehicle, first identification information of a lead vehicle that is situated in front of the vehicle, second identification information of a rear vehicle that is situated behind the vehicle, frontal distance information indicating a distance between the vehicle and a lead vehicle that is situated in front of the vehicle, rear distance information indicating a distance between the vehicle and a rear vehicle that is situated behind the vehicle, left distance information indicating a distance between the vehicle and an object that is situated to a left side of the vehicle, right distance information indicating a distance between the vehicle and an object that is situated to a right side of the vehicle, or any combination thereof.

16. A method for artificial intelligence or machine learning (AI/ML) at a device, comprising:
obtaining training data indicative of trajectory information of an ego vehicle and environmental information indicative of one or more environmental characteristics relative to an ego vehicle;
determining one or more ground truth constraints based at least in part on the training data; and
training an artificial intelligence or machine learning (AI/ML) model to output a predicted trajectory of the ego vehicle and one or more predicted constraints for ego vehicle control, wherein training the AI/ML model is based at least in part on an input of the environmental information to the AI/ML model and is in accordance with a cost function that is based at least in part on the one or more ground truth constraints.

17. The method of claim 16, wherein training the AI/ML model is performed without one or more predicted travel paths for one or more objects in a vicinity of the ego vehicle.

18. The method of claim 16, wherein the one or more ground truth constraints comprise, for one or more time instances of the training data, detection information of one or more objects within a distance from an ego vehicle, first identification information of a lead vehicle that is situated in front of an ego vehicle, second identification information of a rear vehicle that is situated behind an ego vehicle, frontal distance information indicating a distance between an ego vehicle and a lead vehicle that is situated in front of an ego vehicle, rear distance information indicating a distance between an ego vehicle and a rear vehicle that is situated behind an ego vehicle, left distance information indicating a distance between an ego vehicle and an object that is situated to a left side of an ego vehicle, right distance information indicating a distance between an ego vehicle and an object that is situated to a right side of an ego vehicle, or any combination thereof.
